(19) United States
(12) Patent Application Publication
(10) Pub. No.: US 2023/0368006 A1
(43) Pub. Date: Nov. 16, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Tomoki TAMINATO, Kanagawa (JP)

(21) Appl. No.: 18/311,258

(22) Filed: May 3, 2023

(30) Foreign Application Priority Data
May 12, 2022 (JP) 2022-078954

(51) Int. Cl. G06N 3/0495; G06N 3/09

(52) U.S. Cl. CPC G06N 3/0495; G06N 3/09

(57) ABSTRACT

There is provided with an information processing apparatus. An obtaining unit obtains information indicating a size of an output as a result of a first operation in a neural network that performs the first operation using a weight coefficient for input data and a second operation of quantizing a result of the first operation, in order to obtain data of an intermediate layer. A control unit controls the first operation in the neural network to adjust the size of the output based on the information and a quantization parameter used for the quantization.

### BACKGROUND OF THE INVENTION

### Field of the Invention

The present invention relates to an information processing apparatus, an information processing method, and a storage medium.

### Description of the Related Art

In recent years, research and development has been conducted on image recognition techniques using a neural network (NN). Recent NNs have a large number of layers leading to a large calculation amount, but there may be a case with limited calculation resources. Thus, an efficient calculation method has been called for.

As the efficient calculation method, there has been known a method of quantizing data of an NN into a low precision numerical value and performing the calculation. The quantization makes it easier for the NN operation to be performed on devices with limited calculation resources.

According to a technique disclosed in “8-bit Inference with TensorRT”, Szymon Migacz, NVIDIA, May 8, 2017, with an NN learning of which is performed using high precision numerical values, a distribution of output values are obtained using a large amount of data for each layer, and a quantization parameter minimizing the loss of the distribution after the quantization is selected.

### SUMMARY OF THE INVENTION

According to one embodiment of the present invention, an information processing apparatus comprises: an obtaining unit configured to obtain information indicating a size of an output as a result of a first operation in a neural network that performs the first operation using a weight coefficient for input data and a second operation of quantizing a result of the first operation, in order to obtain data of an intermediate layer; and a control unit configured to control the first operation in the neural network to adjust the size of the output based on the information and a quantization parameter used for the quantization.

According to another embodiment of the present invention, an information processing method comprises: obtaining information indicating a size of an output as a result of a first operation in a neural network that performs the first operation using a weight coefficient for input data and a second operation of quantizing a result of the first operation, in order to obtain data of an intermediate layer; and controlling the first operation in the neural network to adjust the size of the output based on the information and a quantization parameter used for the quantization.

According to still another embodiment of the present invention, a non-transitory computer-readable storage medium stores a program which, when executed by a computer comprising a processor and a memory, causes the computer to: obtaining information indicating a size of an output as a result of a first operation in a neural network that performs the first operation using a weight coefficient for input data and a second operation of quantizing a result of the first operation, in order to obtain data of an intermediate layer; and controlling the first operation in the neural network to adjust the size of the output based on the information and a quantization parameter used for the quantization.

Further features of the present invention will become apparent from the following description of exemplary embodiments (with reference to the attached drawings).

### BRIEF DESCRIPTION OF THE DRAWINGS

FIG. 1 is a diagram illustrating an example of a hardware configuration of an information processing apparatus according to a first embodiment.

FIG. 2 is a diagram illustrating an example of a functional configuration of the information processing apparatus according to the first embodiment.

FIG. 3 is a flowchart illustrating an example of output distribution calculation processing according to the first embodiment.

FIG. 4 is a diagram illustrating an example of a model of an NN of the information processing apparatus according to the first embodiment.

FIG. 5 is a flowchart illustrating an example of weight determination processing according to the first embodiment.

FIG. 6 is a diagram illustrating an example of a functional configuration of an information processing apparatus according to a second embodiment.

FIG. 7 is a diagram illustrating weight correction for a model of an NN according to the second embodiment.

FIG. 8 is a diagram illustrating an example of a functional configuration of an information processing apparatus according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In general, a small quantization parameter for quantizing an output of an intermediate layer of an NN leads to a high risk of deterioration of recognition accuracy of the NN due to truncation or rounding of the output value. On the other hand, a large quantization parameter leads to low resolution for the output value which may result in deteriorated recognition accuracy of the NN. The quantization parameter individually settable for each layer enables suppression of the deterioration of the recognition accuracy, but is likely to result in combinational explosion.

An embodiment of the present invention provides an information processing apparatus that suppresses deterioration of recognition accuracy, with a quantization parameter for an intermediate layer of a neural network including a quantization operation set to be small.

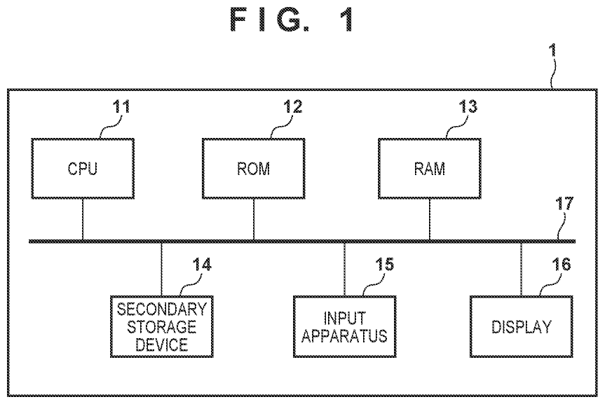

FIG. 1 is a block diagram illustrating an example of a hardware configuration of the information processing apparatus 1 according to the present embodiment. The information processing apparatus 1 according to the present embodiment includes a CPU 11, a ROM 12, a RAM 13, a storage unit 14, an input/output unit 15, a display unit 16, and a connection bus 17.

The CPU 11 is a central processing unit and executes a control program stored in the ROM 12 and the RAM 13 to implement various types of control performed by functional units of the information processing apparatus 1 described below. In addition, the CPU 11 executes a Single Instruction, Multiple Data (SIMD) instruction, and collectively processes 8-bit integer type operations in inference processing to be described below.

The ROM 12 is a nonvolatile memory, and stores data including a control program and various parameters. Here, the control program is executed by the CPU 11 to realize various types of control processing. The RAM 13 is a volatile memory, and temporarily stores an image as well as a control program and a result of executing the program.

The storage unit 14 is a rewritable secondary storage device such as a hard disk or a flash memory, and stores various types of data used for each processing according to the present embodiment. The storage unit 14 can store, for example, an image used for calculation of a quantization parameter as well as a control program and a result of processing thereof, and the like. These various types of information are output to the RAM 13 to be used for program execution by the CPU 11.

The input/output unit 15 functions as an interface with the outside. The input/output unit 15 obtains a user input, and may be, for example, a mouse and a keyboard, a touch panel, or the like. The display unit 16 is, for example, a monitor, and can display a processing result of a program, an image, and the like. The display unit 16 may be implemented as a touch panel together with the input/output unit 15, for example. The functional units of the information processing apparatus 1 are communicably connected to each other through the connection bus 17, and transmit and receive data to and from each other.

In the present embodiment, each processing described below is implemented by software using the CPU 11. However, the processing may be partially or entirely implemented by hardware as long as the processing can be similarly executed. As the hardware, a dedicated circuit (ASIC), a processor (reconfigurable processor or DSP), or the like may be used. The software for executing each processing may be obtained via a network or various storage media and executed by a processing apparatus such as a personal computer.

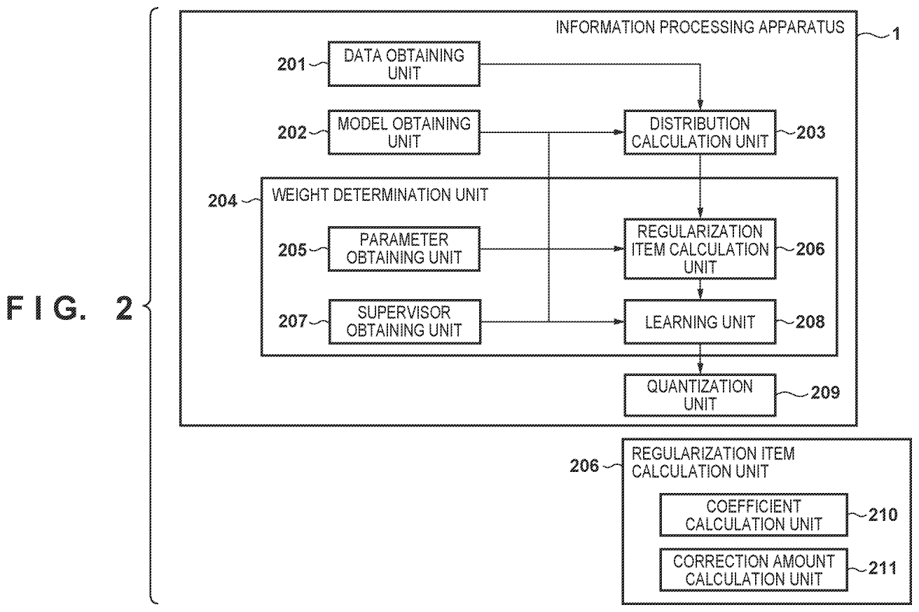

FIG. 2 is a block diagram illustrating an example of a functional configuration of the information processing apparatus 1 according to the present embodiment. In order to obtain data of the intermediate layer of the NN, the information processing apparatus 1 according to the present embodiment obtains information (output distribution) indicating a size of an output of a first operation in the NN that performs the first operation with a weight coefficient being input data and a second operation of quantizing a result of the operation. Next, the information processing apparatus 1 controls the first operation in the NN so as to adjust the size of the output from the first operation based on the obtained output distribution and the quantization parameter used for the quantization. For this purpose, the information processing apparatus 1 includes a data obtaining unit 201, a model obtaining unit 202, a distribution calculation unit 203, a weight determination unit 204, and a quantization unit 209. The weight determination unit 204 includes a parameter obtaining unit 205, a regularization item calculation unit 206, a supervisor obtaining unit 207, and a learning unit 208. The regularization item calculation unit 206 includes a coefficient calculation unit 210 and a correction amount calculation unit 211. The processing by each of these functional units will be described in detail below.

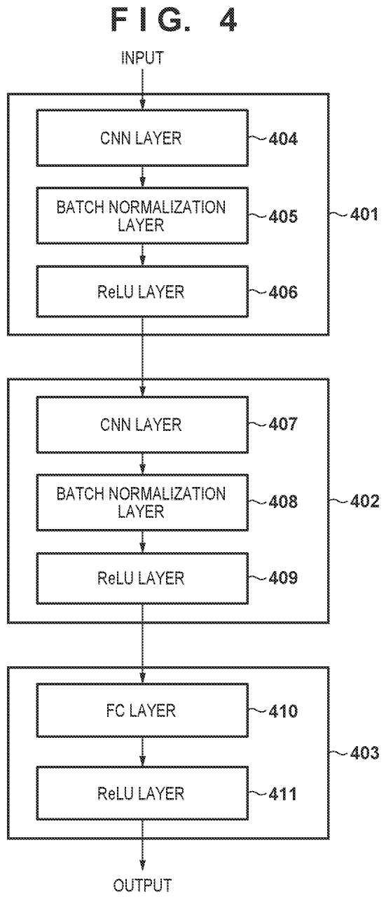

FIG. 4 is a diagram illustrating an example of a model of the NN used in the present embodiment, and illustrates three layers 401 to 403 including the intermediate layer of the NN. The layers illustrated in FIG. 4 are combinations of a CNN layer, a normalization layer, a ReLU layer, and an FC layer. A convolutional neural network (CNN) is a type of NN that executes convolution processing. A fully connected layer (FC) is a type of NN referred to as a fully connected layer. A rectified linear unit (ReLU) is one type of activation function. Since processing executed in each of the layers is basically the same as that executed in a general NN, detailed description thereof will be omitted.

Here, a set from the NN to the activation function is assumed to be one layer unit. For example, the layer 401 includes a CNN layer 404, a normalization layer 405, and a ReLU layer 406 as one unit layer. The layer 402 is an intermediate layer having a layer configuration similar to that of the layer 401. The layer 403 includes an FC layer 410 and a ReLU layer 411 as one unit layer. Hereinafter, the output of a layer (intermediate layer) refers to the output of one unit layer. In the following description, when a layer i (1≤i) is described, i indicates an index of one unit layer. In the example illustrated in FIG. 4, a layer 1 corresponds to the layer 401, a layer 2 corresponds to the layer 402, and a layer 3 corresponds to the layer 403.

The layer 401 is an input layer and performs a convolution operation on an input image. A layer 403 is an output layer that outputs a likelihood map of a specific object in the input image. This is merely an example, and the number of layers may be different, or a layer executing processing different from those described above may be included. For example, the layers may include a pooling layer. While a learned model is used for the NN in this example, a model initialized by using a known NN weight initialization method as described in “Delving Deep into Rectifiers: Surpassing Human-Level Performance on ImageNet Classification”, Kaiming He, Xiangyu Zhang, Shaoqing Ren, Jian Sun; Proceedings of the IEEE International Conference on Computer Vision (ICCV), 2015, pp. 1026-1034 may be used instead.

In the information processing apparatus 1 according to the present embodiment, input data is input to the NN and an inference result is output. Here, when the input data is input to the NN, the distribution calculation unit 203 obtains an output distribution through the first operation which is an operation using a weight coefficient (hereinafter, simply referred to as a weight) in each intermediate layer. An output distribution Yᵢ is information indicating the size of an output of a layer i, and may be, for example, the maximum value of the output of the layer i or a value corresponding to top 99.9% of output values of the layer i in the ascending order. The output distribution Yᵢ may be a value calculated by the following Formula (1) using an average μᵢ and a standard deviation σᵢ of the output values. In the formula, n can be set to a value conforming to a desired condition such as 4 or 5 for example. Thus, in the present embodiment, the output distribution is information calculated based on the distribution of the outputs obtained by the first operation, and in particular, may be calculated as information indicating the upper limit excluding the outlier of the outputs. In the present embodiment, the output distribution is obtained from N×M output values, where N is the number of mini batches of the input data and M is the number of output channels of the layer.

Yᵢ=μᵢ+nσᵢ Formula (1)

The information processing apparatus 1 according to the present embodiment can set the quantization parameter and perform the second operation of quantizing the data of the NN including the result of the first operation (layer output). If the layer output to be quantized exceeds the quantization parameter, it is likely that many output values are truncated or rounded off in the quantization. Thus, the recognition accuracy of the NN may be deteriorated. In view of this, the information processing apparatus 1 controls the first operation so as to adjust the size of the output from the layer based on the output distribution and the quantization parameter. In particular, by adjusting the weight of the NN to achieve a small output distribution with respect to the quantization parameter (for example, equal to or smaller than the quantization parameter), the deterioration of the recognition accuracy in the quantization can be suppressed without using a large quantization parameter.

The information processing apparatus 1 according to the present embodiment performs learning of the NN based on the quantization parameter, to achieve a small output distribution. Such an example will be described below.

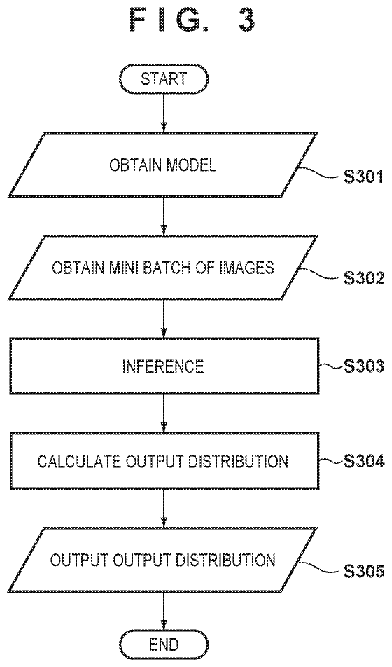

FIG. 3 is a flowchart illustrating an example of processing up to output of an output distribution, executed by the information processing apparatus 1 according to the present embodiment. In S301, the model obtaining unit 202 obtains a model of the NN.

In S302, the data obtaining unit 201 obtains a mini batch of images. This mini batch is input data to the NN, including one or more images, and is a set of input images to be input to the NN obtained in S301. For example, the mini batch is assumed to be a set of 32 images (the number of images included in the mini batch is N (N=32)). While a model for detecting a recognition target in an image is used in the present embodiment, an image included in the mini batch may or may not include the recognition target.

In S303, the distribution calculation unit 203 inputs the mini batch images obtained in S302 to the model obtained in S301, and executes inference processing. Here, the distribution calculation unit 203 performs an operation using a weight coefficient in each layer of the NN for the input data, to obtain an output of the layer.

The distribution calculation unit 203 in S304 aggregates the output values from the respective layers obtained in the inference processing executed in S303, and obtains the output distribution Yᵢ based on the aggregated output values. In S305, the distribution calculation unit 203 outputs a set {Yᵢ} of values of the output distributions of the respective layers.

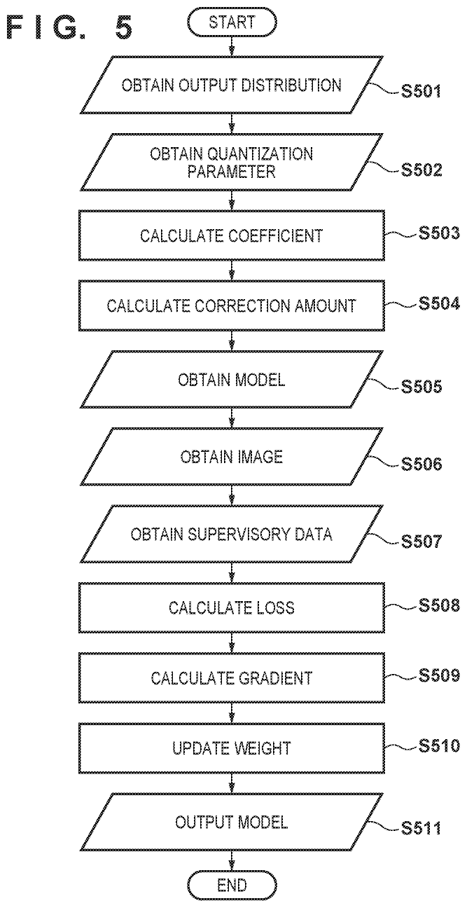

As described above, the information processing apparatus 1 according to the present embodiment suppresses deterioration of the recognition accuracy due to the quantization, through learning (by determining the weight of the NN) to make such an output distribution Yᵢ small. In other words, the information processing apparatus 1 performs learning in such a manner that the output distribution exceeding the quantization parameter results in a large loss. FIG. 5 is a flowchart illustrating an example of processing of determining the weight of the NN in single learning using the set {Yᵢ}, executed by the weight determination unit 204 according to the present embodiment. Since a known NN learning method can be basically used for S501 to S511, a detailed description thereof will be omitted.

In S501, the regularization item calculation unit 206 obtains the set {Yᵢ} of values of the output distribution. In S502, the parameter obtaining unit 205 obtains a quantization parameter q. In the present embodiment, the quantization parameter q is set in advance and is assumed to be q=4 in the following description, but a value calculated according to another parameter may be used as the quantization parameter q.

In the example illustrated in FIG. 4, the output value is 0 or more since each layer is output through the ReLU layer. For example, since q=4, the information processing apparatus 1 may set the upper limit of the output distribution of each layer to be 4 or less. In this case, the range of outputs of each layer of the NN with 32 bit single precision is [0,4]. When this is quantized into 8 bit precision, the output value of the layer is quantized with (bin width)=4/256=0.015625. For example, when the output value of the layer of the NN with 32 bit single precision is 3.1, the output is 3.09375 when quantized to 8 bit. This value is converted into an 8 bit integer of [0,255] as follows 3.09375×256/4=198.

In S503, the coefficient calculation unit 210 calculates a coefficient C in the layer i using the output distribution Yᵢ of the layer i and the quantization parameter q obtained. This C thus calculated is used in loss calculation processing in S508 described below. The coefficient C is not particularly limited as long as it is a value that increases with Yᵢ. For example, the coefficient C may be calculated by the following Formula (2) or Formula (3), and a power of Yᵢ may be used instead of Yᵢ in Formula (2) and Formula (3).

$$C = \frac{{Y}_{i}}{q} \qquad Formula ( 2 )$$

$$C = {e}^{\frac{{Y}_{i}}{q}} \qquad Formula ( 3 )$$

In S504, the correction amount calculation unit 211 calculates a correction amount D for correcting the regularization item using the output distribution Yᵢ and the quantization parameter q. The correction amount D is used for the loss calculation processing in S508 described below. The correction amount D is determined by, for example, the following Formula (4) to be large when Yᵢ exceeds the quantization parameter q.

$$[ Equation 1 ]$$

$$D = \{ \begin{matrix}{e}^{\frac{- {( {Y}_{i} - q )}^{2}}{{σ}^{2}}} - 1 & if {Y}_{i} > q \\ 0 & if {Y}_{i} \leq q\end{matrix} \qquad Formula ( 4 )$$

In S505, the learning unit 208 obtains the model of the NN for which the learning is performed from the model obtaining unit 202. In S506, the supervisor obtaining unit 207 obtains a mini batch corresponding to the input image to be used as supervisory data. In S507, the supervisor obtaining unit 207 obtains correct answer data for the mini batch obtained in S506, and obtains the supervisory data as a combination of these. The correct answer data is data including information indicating a detection target region in the mini batch. Although image data that is the same mini batch as that used for calculating the output distribution in S302 is used in this example, the present invention is not particularly limited to this, and a different mini batch may be used.

In S508, the learning unit 208 executes inference processing with the mini batch obtained in S506 being an input, using the model obtained in S505, to calculate a loss (objective function) between the output and the correct answer data obtained in S507. When the task of the NN is a task of detecting a region, the loss function which is the objective function may be a square error or a cross-entropy error. The learning unit 208 calculates a regularization item for each layer and adds the regularization item to the loss. The regularization item for the layer i may be given as λ(wᵢ)² (as L2 regularization item), where wᵢ is the weight of the layer i. Note that the regularization item may be given as L1 regularization item or may be given by a combination between the items. Note that λ is a coefficient applied to the regularization item and is set based on the coefficient C calculated in S503 and the correction amount D calculated in S504. For example, λ may be implemented, for example, as in the following Formula (5). Thus, a simple description “regularization item” in the following description indicates a regularization item including the loss function used by the learning unit 208.

$$[ Equation 2 ]$$

$$\ddot{e} = \{ \begin{matrix}α C + β D & if {Y}_{i} > q \\ α C & if {Y}_{i} \leq q\end{matrix} \qquad Formula ( 5 )$$

In the formula, α and β are constants. With such a configuration, the learning is performed in such a manner that when Yᵢ exceeds q, a larger value of the excess leads to a larger loss. Thus, the learning of the NN proceeds without the output value of the layer exceeding the quantization parameter, whereby deterioration of the recognition accuracy due to quantization can be suppressed.

In S509, the learning unit 208 calculates a gradient by backpropagation using the loss calculated in S508, and calculates an update amount of the weight of the model. In the S510, the learning unit 208 updates the weight of the NN. Since a known NN learning method can be basically used for S501 to S511 in S511, a detailed description thereof will be omitted. The model with the updated weight is output, and the processing is terminated. With such learning processing repeated until the learning loss or the recognition accuracy converges (to a desired precision), the weight of the NN model can be determined.

In this way, the learning unit 208 can perform learning of the NN to make the output distribution Yᵢ small with respect to the quantization parameter q. Note that the processing described with reference to FIG. 5 is an example, and the calculation processing for the loss is not particularly limited as long as learning is performed such that the Yᵢ exceeding q results in a large loss.

The quantization unit 209 quantizes the weight and output of the NN, as a result of the learning by the weight determination unit 204. A known technique can be used for quantization of the NN, and thus a detailed description thereof will be omitted. In the quantization processing according to the present embodiment, it is assumed that a 32 bit value of a single precision floating point is quantized to an integer 8 bit value, but the type and the value are not limited these as long as the quantization is executed.

With such a configuration, the information processing apparatus 1 first obtains the information indicating the size of the output of the first operation using the weight coefficient for the input data in the intermediate layer of the NN. Next, the information processing apparatus 1 can control the first operation so as to adjust the size of the output described above based on the obtained information and the quantization parameter used for the quantization of the NN including the result of the first operation. Therefore, the deterioration of the recognition accuracy due to the quantization can be suppressed by reducing the size of the output of the calculation in the intermediate layer without increasing the quantization parameter. In addition, by setting the quantization parameter to a constant common to the layers, it is possible to reduce the processing load compared with a case where an individual quantization parameter is set for each layer, and to prevent the quantization parameter from resulting in a combinational explosion.

### Second Embodiment

In the first embodiment, an example has been described in which learning of the weights of the NN is performed so as to adjust the output distribution based on the output distribution and the quantization parameter. On the other hand, an information processing apparatus 6 according to the second embodiment adjusts the output distribution by correcting the weight of the NN based on the output distribution and the quantization parameter.

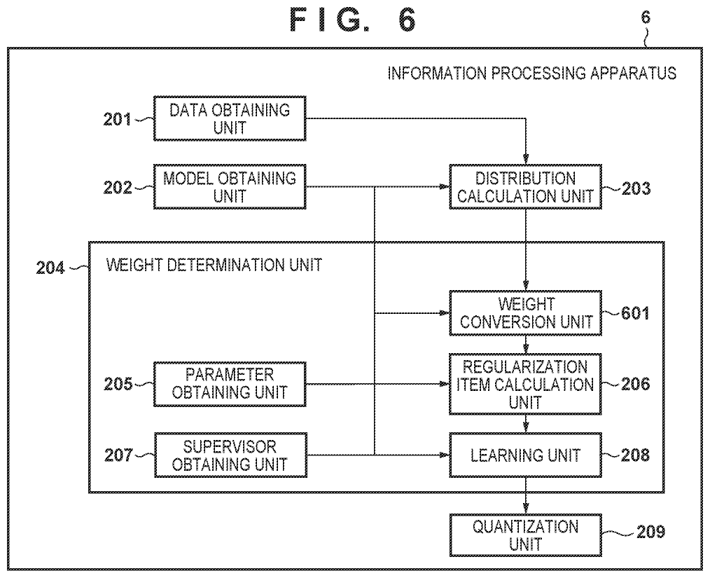

FIG. 6 is a block diagram illustrating an example of a functional configuration of the information processing apparatus 6 according to the present embodiment. The information processing apparatus 6 has a similar configuration and can execute similar processing to that in the first embodiment described with reference to FIG. 2 except that the weight determination unit 204 includes a weight correction unit 601, and thus redundant description will be omitted. Also in the present embodiment, the following description is given assuming that the quantization parameter q is 4.

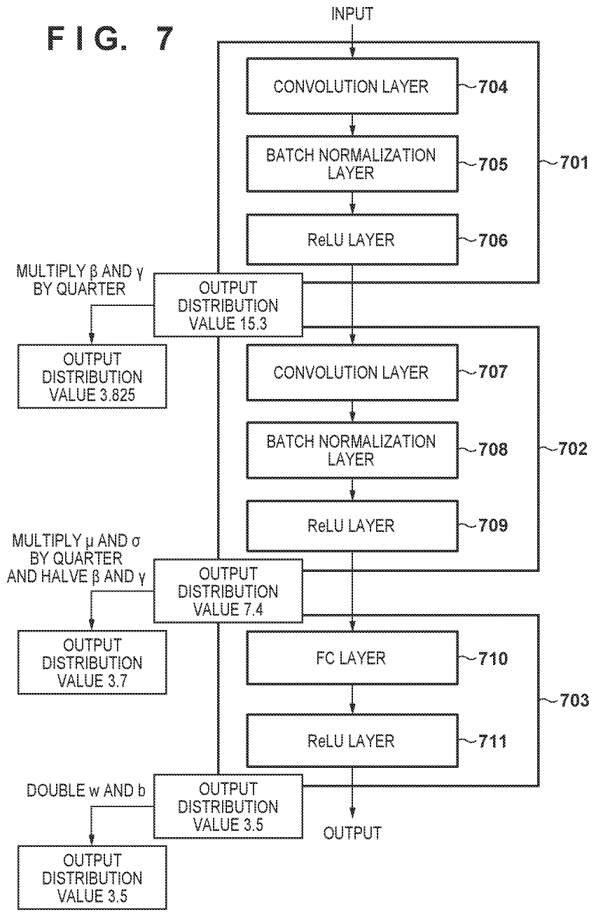

FIG. 7 is a diagram illustrating an example of a model of an NN used in the present embodiment, and is used to describe an output distribution from each layer included in the NN and processing for converting the output distribution. While three layers 701 to 703 including the intermediate layer of the NN are illustrated in FIG. 7, these layers respectively have similar configurations to the layers 401 to 403 in FIG. 4, and thus redundant description will be omitted.

Since q=4 in the present embodiment, an output value of each layer exceeding 4 is rounded to 4 as a result of the quantization, meaning that the recognition accuracy is deteriorated. In view of this, the weight correction unit 601 corrects the weight of the NN (regardless of the learning) to prevent the output distribution from exceeding the quantization parameter.

The weight correction unit 601 according to the present embodiment corrects the weight of the NN to set the output distribution to equal to or smaller than the quantization parameter. In the example of FIG. 7, the value of the output distribution of a layer 701 is 15.3 and thus is larger than the quantization parameter which is 4. In order to set the value of the output distribution to be equal to or smaller than the quantization parameter, the weight correction unit 601 corrects the weight of the NN to be ¼. The correction multiplying factor can be obtained by, for example, sequentially reducing the value of the output distribution to be 1/1, ½, ⅓, . . . until it reaches 1/M (M is an integer that is equal to or larger than 1) at which the output distribution first reaches or falls below the quantization parameter. In the following, the weight correction unit 601 may correct the weight of a convolution layer (704) or may correct the weight of a batch normalization layer (705). In the present embodiment, when the layers include a batch normalization layer, the weight of the batch normalization layer is corrected. The batch normalization layer according to the present embodiment can calculate the output yᵢ with the following Formula (6), with the input being xᵢ for example. In the formula, μ_{B} and σ_{B} are respectively an average value and a variance value of input value, and are values updated by obtaining a moving average at the time of learning. Furthermore, γ and δ are weight parameters learned by the backpropagation.

$$[ Equation 3 ]$$

$${y}_{i} = \frac{\tilde{a} {x}_{i} - {μ}_{B}}{\sqrt{{σ}_{B}^{2} + δ}} + β \qquad Formula ( 6 )$$

To set the output of the layer 701 to be ¼, the weight parameters γ and δ in Formula (6) may each be multiplied by ¼. In this case, the weight correction unit 601 corrects the weight of the NN by multiplying γ and β by ¼, and outputs the result as the weight of the layer 701.

Then, the weight correction unit 601 corrects the weight in a similar manner in the subsequent layers such as a layer 702. In the example illustrated in FIG. 7, the output of the layer 702 is 7.4, and thus the value of the output distribution needs to be multiplied by ½. Still, since the output value of the layer 701 has been multiplied by ¼, the weight correction unit 601 needs to multiply μ_{B} and σ_{B} of a batch normalization layer 708 by ¼, so that the input scales match. The weight correction unit 601 can set the output value of the layer 702 to be ½, by multiplying the values of β and γ in Formula (6) by ½. Thus, the weight correction unit 601 corrects the weight of the NN, by multiplying μ_{B} and σ_{B} by ¼ and multiplying β and γ by ½, and outputs the result as the weight of the layer 702.

Further, since the output of the layer 703 is 3.5, it is not necessary to change the value of the output distribution. However, since the output distribution is halved in the layer 702, it is necessary to double each of the weight w and the bias b of the FC layer in order to maintain the output value. Thus, the weight correction unit 601 corrects the weight of the NN, by doubling each of a weight w and a bias b of the FC layer and outputting the result as the weight of the layer 703.

The quantization unit 209 may quantize the model of the NN with the weight thus corrected, or may quantize the model of the NN with the learning performed by the regularization item calculation unit 206 and the learning unit 208. The weight correction unit 601 may execute correction processing when the value of the output distribution exceeds a predetermined value (for example, the quantization parameter). Furthermore, for example, the weight correction unit 601 may execute the weight correction processing when learning is performed for a predetermined number of times by the model of the NN.

The weight correction processing by the weight correction unit 601 may be applied to the NN learned to set the value of the output distribution to be small as in the first embodiment, but reduction of the output distribution by the learning is insufficient. Further, the correction processing may be applied to an NN to which the learning of the first embodiment is not applied.

With such processing, the output distribution can be adjusted so as not to exceed the quantization parameter by correcting the weight of the NN. Therefore, the deterioration of the recognition accuracy due to the quantization can be suppressed by reducing the size of the output of the calculation in the intermediate layer without increasing the quantization parameter.

### Third Embodiment

An information processing apparatus 8 according to the present embodiment quantizes the weight of the NN and corrects the regularization item used by the weight determination unit 204 based on the recognition accuracy of the NN on the detection target each of before and after the quantization. For example, the information processing apparatus 8 can adjust the degree of contribution of the normalization term at the time of learning, by evaluating the condition of deterioration of the recognition accuracy due to quantization of the NN and correcting the regularization item in accordance with the condition of deterioration.

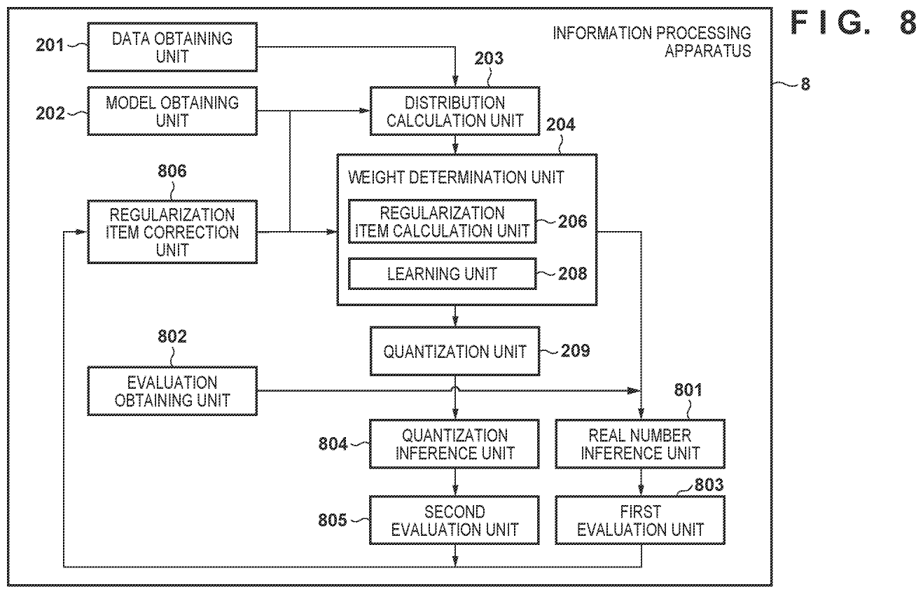

FIG. 8 is a block diagram illustrating an example of a functional configuration of the information processing apparatus 8 according to the present embodiment. The information processing apparatus 8 has a similar configuration and executes similar processing to those of the information processing apparatuses described with reference to FIG. 2 or 6 except that the information processing apparatus 8 includes a real number inference unit 801, an evaluation data obtaining unit 802, a first evaluation unit 803, a quantization inference unit 804, a second evaluation unit 805, and a regularization item correction unit 806. The information processing apparatus 8 according to the present embodiment is described below under an assumption that the learning of the NN has been completed in the manner described in the first embodiment and the second embodiment, but is not particularly limited to this as long as the learned NN is used.

The evaluation data obtaining unit 802 obtains evaluation data that is data for evaluating the recognition accuracy of the NN for the detection target. This evaluation data is prepared in advance and is a set of a mini batch and correct answer data as in the supervisory data used in the first embodiment. The real number inference unit 801 executes inference processing (recognition of a detection target) with the mini batch included in the evaluation data being an input, by using the model of the NN after the learning by the learning unit 208.

The first evaluation unit 803 evaluates the recognition accuracy of the NN for the detection target. Here, it is assumed that the first evaluation unit 803 evaluates the value of a loss (E1) output by the inference processing executed by the real number inference unit 801, as the recognition accuracy. Alternatively, the first evaluation unit 803 may evaluate different information indicating the success rate of recognition, such as the accuracy rate or likelihood of recognition on the detection target, as the recognition accuracy for example. Hereinafter, a simple description “recognition accuracy” refers to recognition accuracy for a detection target.

The quantization inference unit 804 executes the inference processing with the mini batch included in the evaluation data being an input by using the model of the NN (used for the inference by the real number inference unit 801) whose weight has been quantized by the quantization unit 209.

The second evaluation unit 805 evaluates the recognition accuracy of the NN, with the weight quantized, for the detection target, used by the quantization inference unit 804. The evaluation of the recognition accuracy by the second evaluation unit 805 is performed in a similar manner to the evaluation by the first evaluation unit 803, and it is assumed here that a loss E2 output by the inference is evaluated as the recognition accuracy.

The regularization item correction unit 806 corrects the regularization item based on the evaluation of the recognition accuracy by the first evaluation unit 803 and the evaluation of the recognition accuracy by the second evaluation unit 805. Here, the regularization item correction unit 806 may evaluate the deterioration degree of the recognition accuracy of the NN due to the quantization of the weight, by using the evaluation of the recognition accuracy by the first evaluation unit 803 and the evaluation of the recognition accuracy by the second evaluation unit 805, and correct the normalization term using this evaluation.

In the present embodiment, the regularization item correction unit 806 evaluates a deterioration degree F. of the recognition accuracy of the NN due to the quantization of the weight, by using the following Formula (7). Since E1 and E2 are values of the loss function, a larger F results in a larger deterioration of the recognition accuracy due to quantization, meaning that the deterioration degree is higher with larger F.

F=E1+E2 Formula (7)

The regularization item correction unit 806 may correct the regularization item using the deterioration degree, by calculating a corrected regularization item λ′ using the value of the deterioration degree F. as a coefficient of the regularization item using, for example, the following Formula (8). In this way, it is possible to correct the contribution of the regularization item at the time of learning in accordance with the deterioration degree of the recognition accuracy. Specifically, when the deterioration degree is low, the degree of contribution of the normalization term at the time of learning can be reduced, and when the deterioration degree is high, the degree of contribution of the normalization term at the time of learning can be increased.

λ^{ë}′=Fλ Formula (8)

The normalization term correction processing does not need to be executed each time update processing for the weight of the NN by the learning unit 208, and may be executed each time the learning is performed for predetermined number of times for example.

With such a configuration, it is possible to correct the regularization item at the time of learning in accordance with a change in recognition accuracy before and after quantization of the NN. Therefore, it is possible to adjust the degree of contribution of the regularization item at the time of learning in accordance with the deterioration degree of the recognition accuracy of the NN due to quantization.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-078954, filed on May 12, 2022, which is hereby incorporated by reference herein in its entirety.

What is claimed is:

1. An information processing apparatus comprising:
an obtaining unit configured to obtain information indicating a size of an output as a result of a first operation in a neural network that performs the first operation using a weight coefficient for input data and a second operation of quantizing a result of the first operation, in order to obtain data of an intermediate layer; and
a control unit configured to control the first operation in the neural network to adjust the size of the output based on the information and a quantization parameter used for the quantization.

2. The information processing apparatus according to claim 1, wherein the information indicating the size of the output is information calculated based on a distribution of values of the output.

3. The information processing apparatus according to claim 2, wherein the information indicating the size of the output is information indicating an upper limit excluding an outlier of the output.

4. The information processing apparatus according to claim 1, wherein the control unit controls the first operation by controlling a weight coefficient of the neural network, through learning with which the size of the output exceeding the quantization parameter results in a large loss.

5. The information processing apparatus according to claim 4, wherein the loss is calculated by a loss function including a regularization item that is large when the size of the output exceeds the quantization parameter.

6. The information processing apparatus according to claim 5, further comprising:
a first evaluation unit configured to evaluate a recognition accuracy of the neural network for a detection target;
a quantization unit configured to quantize the weight coefficient of the neural network;
a second evaluation unit configured to evaluate the recognition accuracy of the neural network for the detection target after the weight coefficient has been quantized; and
a correction unit configured to correct the regularization item included in the loss function, based on the recognition accuracy evaluated by the first evaluation unit and the recognition accuracy evaluated by the second evaluation unit.

7. The information processing apparatus according to claim 6, further comprising a third evaluation unit configured to evaluate a deterioration degree of the recognition accuracy of the neural network for the detection target due to the quantization of the weight coefficient using the recognition accuracy evaluated by the first evaluation unit and the recognition accuracy evaluated by the second evaluation unit, wherein
the correction unit corrects the regularization item using the deterioration degree.

8. The information processing apparatus according to claim 1, wherein the control unit adjusts the size of the output by correcting the weight coefficient of the intermediate layer.

9. The information processing apparatus according to claim 8, wherein the control unit controls the first operation in the neural network when the size of the output exceeds a predetermined value.

10. An information processing method comprising:
obtaining information indicating a size of an output as a result of a first operation in a neural network that performs the first operation using a weight coefficient for input data and a second operation of quantizing a result of the first operation, in order to obtain data of an intermediate layer; and
controlling the first operation in the neural network to adjust the size of the output based on the information and a quantization parameter used for the quantization.

11. A non-transitory computer-readable storage medium storing a program which, when executed by a computer comprising a processor and a memory, causes the computer to:
obtaining information indicating a size of an output as a result of a first operation in a neural network that performs the first operation using a weight coefficient for input data and a second operation of quantizing a result of the first operation, in order to obtain data of an intermediate layer; and
controlling the first operation in the neural network to adjust the size of the output based on the information and a quantization parameter used for the quantization.
